(19) United States
(12) Patent Application Publication
(10) Pub. No.: US 2008/0192754 A1
(43) Pub. Date: Aug. 14, 2008

(54) Routing system and method for managing rule entries of ternary content addressable memory in the same

(76) Inventors: Yoon-Jin Ku, Seongnam-si (KR); Bong-Cheol Kim, Suwon-si (KR)

Correspondence Address: ROBERT E. BUSHNELL, 1522 K STREET NW, SUITE 300, WASHINGTON, DC, 20005-1202, US

(21) Appl. No.: 12/068,365

(22) Filed: Feb. 5, 2008

(30) Foreign Application Priority Data
Feb. 12, 2007 (KR) 10-2007-0014293

(51) Int. Cl. H04L 12/56

(52) U.S. Cl. 370/395.32

(57) ABSTRACT

A method of managing rule entries of a Ternary Content Addressable Memory (TCAM) in a routing system includes: creating a hash table having a hash key corresponding to each entry; creating a single linked list for linking nodes, the single linked list using the entry of the hash table as a head node and including rule IDs and sequence IDs assigned according to a rule input order; and a double linked list having an independent head node, the double linked list bidirectionally linking the nodes constituting the single linked list according to an order of the sequence IDs. Thus, the packet classifying/filtering rule can be easily added to the TCAM or deleted from the TCAM only with minimal information. Also, the sequence ID reassignment process, required for storing as many rules in the TCAM as possible according to the priority of the rules, is performed when a certain time elapses following rule addition or deletion, thereby reducing a latency that may be caused upon setting the packet classifying/filtering rule.

### CLAIM OF PRIORITY

This application makes reference to, incorporates the same herein, and claims all benefit accruing under 35 U.S.C. §119(a) from an application for ROUTING SYSTEM AND METHOD FOR MANAGING RULE ENTRIES OF TERNARY CONTENT ADDRESSABLE MEMORY IN THE SAME, earlier filed in the Korean Intellectual Property Office on the 12 Feb. 2007 and there duly assigned Serial No. 2007-0014293.

### BACKGROUND OF THE INVENTION

1. Field of the Invention

The present invention relates to a routing system and a method for managing rule entries of a Ternary Content Addressable Memory (TCAM) in the routing system, and more particularly, to a table managing method for rapidly storing rules in a TCAM by using a hash table, and a single linked list and a double linked list associated with the hash table.

2. Description of the Related Art

When a routing process is implemented by software executed in a processing environment, a routing speed in the routing process may not keep up with a packet input speed, resulting in a bottleneck situation. In the routing process, a traffic flow speed is affected by a packet forwarding process in which new header information is added to an input packet, which is then transmitted. To increase the routing speed, a high-speed forwarding engine technique only for packet forwarding has been developed.

To increase a packet forwarding speed, it is necessary to shorten a lookup time in an IP address table for obtaining new header information for an input packet. To shorten the lookup time, a software-based method and a hardware-based method have been studied.

The software-based method uses a compression algorithm to reduce use of a memory and uses a high-speed memory, such as a cache memory or a Static Random Access Memory (SRAM), to improve routing lookup. Use of the software-based method can improve performance of a microprocessor, increase a hit rate for the cache memory, and directly obtain benefits from a high-speed Front Side Bus (FSB). However, the software-based method involves multiple algorithms that must be entirely recomposed upon a routing update. Furthermore, the average search efficiency may be excellent but overall search efficiency is degraded when a tree structure is dense. In the worst case, 32 memory accesses may be required.

Examples of the hardware-based method include a method for linearly mapping an IP address to a memory using a memory, and a method using a compression algorithm implemented by hardware. The hardware-based method can improve a routing speed through pipelining and prevent the routing speed from being degraded due to operation or instructions upon formatting an Operating System (OS) when the method is implemented by a microprocessor.

In the past, where an IP address lookup process was performed by software, IP address information was constructed in a tree format. As high-speed lookup has gradually become required, it has become necessary to implement and perform the lookup process using hardware. However, the tree-format algorithm is difficult to implement using hardware and is limited in capacity and speed.

Recently, a hardware-based lookup scheme has been widely used. This scheme uses a Content Addressable Memory (CAM). The CAM is accessed using an actual data content as an address when data is written to the CAM or read from the CAM. The CAM can search an address at which a value associated with data is located, using the data, and can perform an Exclusive Or (XOR) operation for comparison on each cell. The CAM has an associative memory structure in which external information is compared with stored content in a reading and writing operation, unlike an existing Random Access Memory (RAM) structure. The CAM is used for a search engine in a network router because of such characteristics.

When IP information is input, the CAM can immediately provide information on a corresponding port in one clock. Moreover, use of a Ternary CAM (TCAM) capable of storing information of which value is Don't Care, as well as 0 and 1, allows for relatively easy implementation of Longest Prefix Match (LPM).

A recently required packet classifying/filtering function is difficult to implement on an IP forwarding engine. For example, packet classification requires referring to a 5-tuple, i.e., a destination IP address, a source IP address, a source/destination port number, and a protocol field, which must be compared with previously set packet filtering rules for each packet. This is much more complex than the IP address lookup.

A TCAM compares a search key with all entries in the Ternary CAM in parallel within a very short time of 10˜20 nanoseconds. Since mask bit strings dependent on content bit strings exist in the TCAM, it is not necessary to compare all the content bit strings with the search key. The TCAM indicates information on an entry first matching the search key among the entries in the TCAM, as a search result.

In general, a routing system using a TCAM includes a network processor, the TCAM, and a subsidiary memory. The network processor includes an interface, an entry manager, and a lookup processor.

The interface provides entry management information to the entry manager, in which the entry management information includes packet classifying/filtering rule information received from a user via a Command Line Interface (CLI), and information for adding/deleting any rule in the TCAM. The rule indicates forwarding information for a packet transmitted to the routing system, and the rule includes information that may be differently composed by the user. In general, the rule includes source IP address, destination IP address, transmit port number, receive port number, protocol type, and packet forwarding information.

The entry manager adds or deletes rules to or from the TCAM according to entry management information. When the entry management information provided by the interface indicates a rule addition, the entry manager converts the rule input from the user into an entry format for the TCAM and stores the resultant rule in the TCAM. When the entry management information provided by the interface indicates a rule deletion, the entry manager deletes the rule from the TCAM.

The lookup processor acquires packet forwarding information by looking up the TCAM using a received packet itself and interface information for the received packet (e.g., an interface ID and a direction). The lookup processor filters the packet or applies a packet classification-dependent policy according to the packet forwarding information.

The TCAM stores a plurality of rules, and the subsidiary memory stores the forwarding information for a packet corresponding to each rule stored in the TCAM. It is common for the subsidiary memory to be implemented by a Zero Bus Turnaround (ZBT) SRAM. The packet forwarding information includes forwarding permission/denial/classification information for a packet received by the network processor.

FIG. 1 is a view of a process of searching entry information in a TCAM using a search key and a mask.

The TCAM simultaneously compares a given search key with all stored entries to search for an entry that first matches the search key. In this process, since the TCAM includes mask bit strings dependent on content bit strings, as mentioned above, it is not necessary to compare all the content bit strings with the search key. That is, Don't Care in a mask portion of FIG. 1 does not need to be considered for search. Portions of the search key other than Don't Care in the mask are compared with the content bit string, and the result value is shown as “Compare” in a data array portion of FIG. 1.

FIG. 2 is a view of a correspondence relationship between a TCAM and a subsidiary memory in a routing system.

As shown in FIG. 2, rules of the TCAM 100 correspond to packet forwarding information of the subsidiary memory 200. Each rule entry stored in the TCAM 100 includes a 5-tuple typically required for packet classifying/filtering.

Each rule entry also includes information on an interface to which the rule is applied, for example, an interface ID 116 and a direction 117. This gives consideration to a case where the rule is separately applied to ingress or egress traffic of a specific interface, as well as a case where the rule is generally applied to an entire routing system.

If the rule entry includes only the 5-tuple, the lookup processor of the routing system acquires packet forwarding information 210 by looking up the TCAM with respect to a received packet. This requires a separate check if the packet forwarding information 210 has been applied to the interface. To implement a high-speed lookup by reducing a check time, information on the 5-tuple and the interface to which the rule is applied is generally included in the rule entry.

FIG. 3 is a view of a mechanism for managing mapping information between a priority of rule information and an entry storage location of a TCAM.

The TCAM stores rules in an order of a decreasing priority, and simultaneously compares a given search key with all stored entries to look up an entry that first matches the search key. This operation of the TCAM requires classifying/filtering rule information for a packet having the highest priority to be stored in a first entry of the TCAM. Accordingly, it is necessary to have mapping information between the priority of packet classifying/filtering rule information input from a user via a Command Line Interface (CLI) and the entry storage location of the TCAM.

To guarantee the priorities in an input order of the packet classifying/filtering rule information, a sequence ID indicating the storage location of the TCAM increases by 1. The greater the sequence ID value, the lower the priority. For example, first input rule information is assigned rule ID 1 and sequence ID 1. Similarly, subsequently input rule information is sequentially assigned rule ID 2 and sequence ID 2, rule ID 3 and sequence ID 3 . . . , rule ID N and sequence ID N.

Based on the mapping information shown in FIG. 3, rule information corresponding to the respective sequence IDs is stored in corresponding entries of the TCAM.

However, when the mapping information between the packet classifying/filtering rule information and the rule storage locations of the TCAM is managed as in FIG. 3, it is very time consuming to add new rules as the stored rule information increases. Furthermore, deleting the stored rules consumes a lot of rule search time.

As the sequence ID with an increment of 1 is assigned to the added rule information, the last sequence ID can indicate a last storage location of the TCAM. However, if there is an empty entry in the TCAM due to rule deletion, the TCAM is initialized by deleting existing stored rules to add new rule information. Thereafter, the sequence ID beginning with “1” is assigned by referring to the mapping information between the rule information and the sequence ID and the existing rules are stored in the TCAM one by one. The new rule information is then added. In this process, the lookup processor may fail to obtain the packet forwarding information through the TCAM lookup performed on the received packet, and thus, the received packet may not be filtered or the classification-dependent policy may not be applied to the packet.

Accordingly, there is a need for a rule-entry management method by which rule information stored in the TCAM is efficiently managed by rapidly storing or deleting a rule in or from the TCAM without taking a sequence ID reassignment process when a new rule is added to the TCAM or an existing stored rule is deleted.

### SUMMARY OF THE INVENTION

It is an object of the present invention to provide a routing system and a method for rapidly storing rules in a TCAM in the routing system, by which packet classifying/filtering rule can be easily added or deleted to or from the TCAM by more efficiently managing mapping information between packet classifying/filtering rule information and rule storage locations of the TCAM by using a hash table and linked lists.

A first aspect of the present invention provides a method of managing rule entries of a Ternary Content Addressable Memory (TCAM) in a routing system, the method including: creating a hash table having a hash key corresponding to each entry; creating a single linked list for linking the nodes, the single linked list using the entry of the hash table as a head node and including rule IDs and sequence IDs assigned according to a rule input order; and a double linked list having an independent head node, the double linked list bidirectionally linking the nodes constituting the single linked list according to an order of the sequence IDs.

The hash key may include a rule ID for identifying each packet classifying/filtering rule, an interface index to which the rule is applied, and an interface direction.

Each node constituting the linked list may further include information on an interface index to which the rule is applied.

A second aspect of the present invention provides a method of managing rule entries of a Ternary Content Addressable Memory (TCAM) in a routing system, the method including: when a rule to be added to the TCAM is received, creating a hash key corresponding to the received rule and searching a hash table entry matching the hash key; determining whether a node matching information on the rule exists in a single linked list associated with the searched hash table entry; and when the node matching the information on the rule does not exist, adding a new node including information on the received rule before a first node on the single linked list, and adding the new node before a first node on a backward list in a double linked list.

The method may further include, when the new node is added, assigning a sequence ID to the new node while reading the double linked list in an order of increasing sequence Ids.

The method may further include storing the rule at a location of the TCAM indicated by the sequence ID.

The method may further include, when the received rule is a rule to be deleted from the TCAM, performing search to determine whether a node corresponding to the rule ID and an interface index exists in the single linked list, and deleting the rule from a location of the TCAM indicated by a sequence ID included in the node corresponding to the rule ID and the interface index.

The method may further include, when the rule is deleted from the location of the TCAM, deleting the node from the double linked list and the single linked list.

The method may further include, when there is an entry in which a rule is not stored and there is no non-used entry from a sequence ID to be assigned to a subsequently received rule to a last sequence ID, reassigning the sequence ID while sequentially reading the double linked list.

The step of reassigning the sequence ID may be performed following a time corresponding to an absolute value of a value obtained by subtracting the number of entries of the TCAM, available before the last sequence ID, from the number of non-used entries of the TCAM from the sequence ID to be assigned to the subsequently received rule to the last sequence ID.

The step of reassigning the sequence ID may include sequentially reassigning the sequence IDs to the respective nodes constituting the double linked list while reading the double linked list in an order of the decreasing sequence ID, the reassigned sequence IDs beginning with 1.

A third aspect of the present invention provides a routing system including: a network processor to create a hash table including a hash key, a single linked list to link nodes, the single linked list using an entry of the hash table as a head node and including rule IDs, and sequence IDs assigned according to a rule input order, and a double linked list having an independent head node, the double linked list bidirectionally linking the nodes constituting the single linked list according to an order of the sequence IDs; and a Ternary Content Addressable Memory (TCAM) to store a rule included in the node in a TCAM entry indicated by a sequence ID assigned to the rule.

Each entry of the hash table may include a rule ID to identify each packet classifying/filtering rule, an interface index to which the rule is applied, and an interface direction.

The single linked list may use the entry of the hash table as the head node, and sequentially link nodes including information on the rule ID or the interface index corresponding to the sequence ID and the hash key.

The double linked list may link respective nodes constituting the single linked list about the independent head node according to an order of an increasing or decreasing sequence ID.

The network processor may include: an interface to provide entry management information to an entry manager, the entry management information including information on a packet classifying/filtering rule and information for addition or deletion of any rule to or from the TCAM; and the entry manager for creating the hash table, the single linked list, and the double linked list, and storing or deleting any rule to or from the TCAM according to the entry management information by referring to the hash table, the single linked list, and the double linked list.

The network processor may further include a lookup processor to filter a packet or to apply a packet classification-dependent policy according to packet forwarding information obtained by looking up the TCAM.

The system may further include a subsidiary memory to store forwarding information for a packet corresponding to each rule stored in the TCAM.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings, in which like reference symbols indicate the same or similar components, wherein:

FIG. 1 is a view of a process of searching entry information in a TCAM using a search key and a mask;

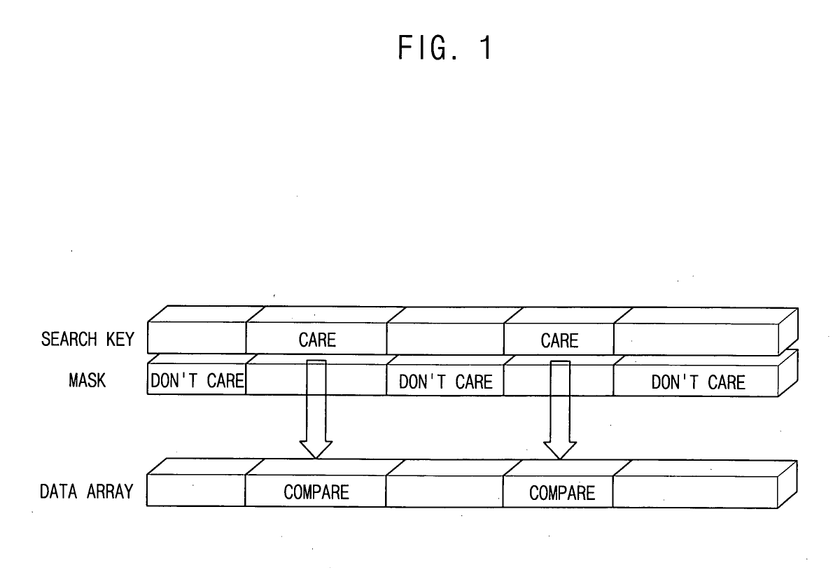

FIG. 2 is a view of a correspondence relationship between a TCAM and a subsidiary memory in a routing system;

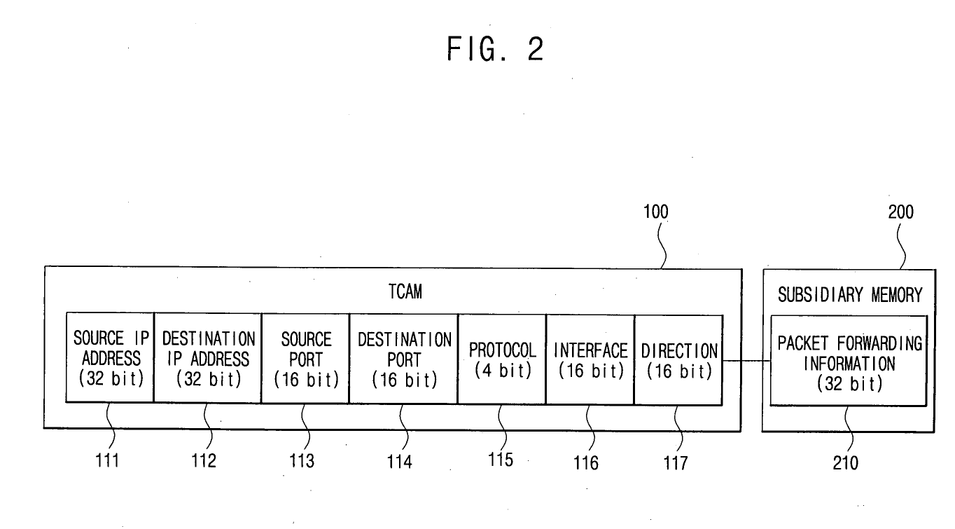

FIG. 3 is a view of a mechanism for managing mapping information between a priority of rule information and an entry storage location of a TCAM;

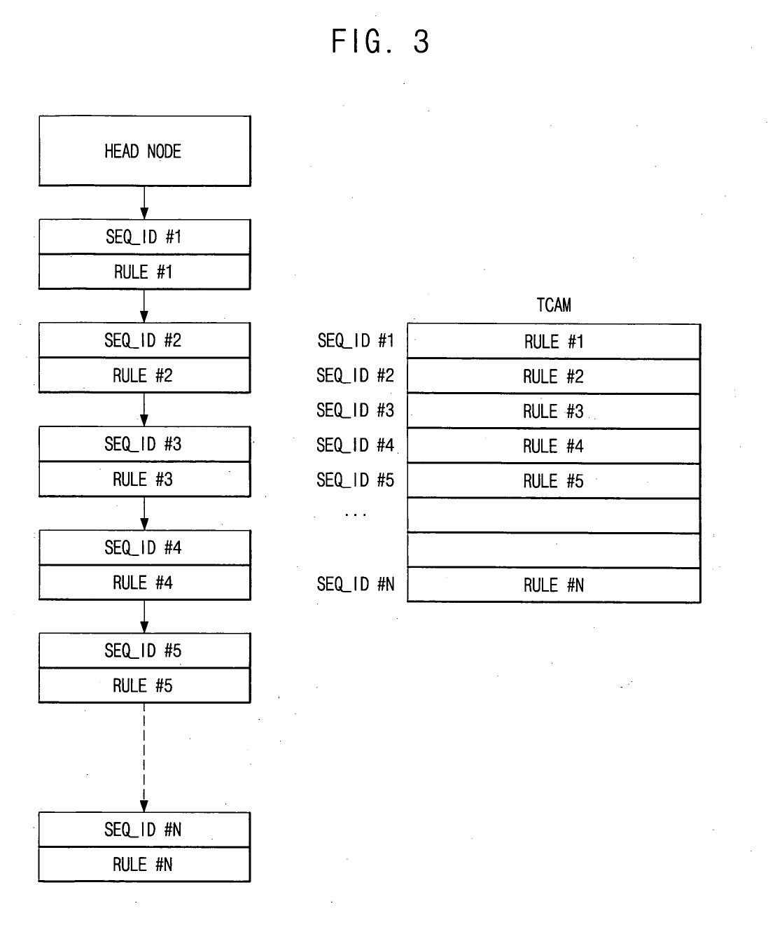

FIG. 4 is a block diagram illustrating a routing system according to the present invention;

FIG. 5 is a view of a connection relationship among a hash table, a single linked list, and a double linked list created to manage rule entries of a TCAM in the present invention;

FIG. 6 is a hash table, a single linked list, a double linked list and a TCAM after a new rule is added in a state where five rules are already stored;

FIG. 7 is a view of a change in a TCAM structure and mapping information after rule #1 and rule #3 are deleted from the TCAM in FIG. 6;

FIG. 8 is a view of a change in a TCAM structure and mapping information after deleted rule #1 and rule #3 are added to the TCAM again;

FIG. 9 is a view of a change in a TCAM structure and mapping information after a sequence ID reassignment process is performed and then rule #7 is added to the TCAM;

FIG. 10 is a flowchart of a process of adding a rule to a TCAM according to the present invention;

FIG. 11 is a flowchart of a sequence ID reassignment process; and

FIG. 12 is a flowchart of a process of deleting a rule from a TCAM according to the present invention.

### DETAILED DESCRIPTION OF THE INVENTION

A routing system and a method of managing rule entries of a ternary content addressable memory in the routing system according to embodiments of the present invention are described in detail below with reference to the accompanying drawings.

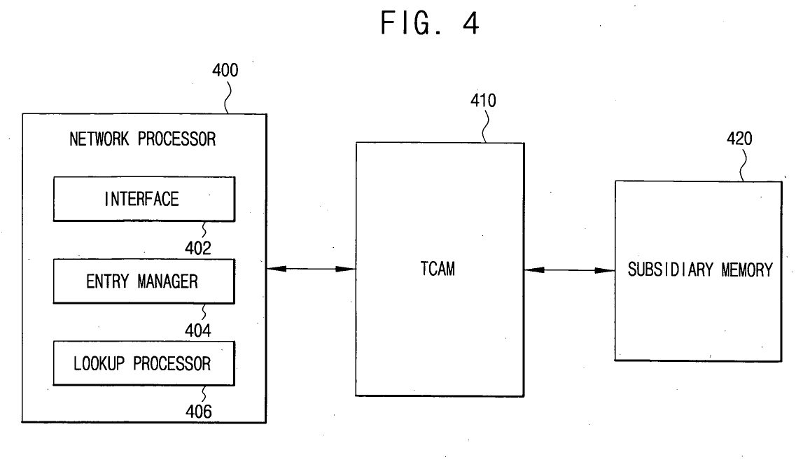

FIG. 4 is a block diagram of a routing system according to an embodiment of the present invention.

The routing system includes a network processor 400, a TCAM (TCAM) 410, and a subsidiary memory 420. The network processor 400 includes an interface 402, an entry manager 404, and a lookup processor 406.

The routing system according to an embodiment of the present invention has the same basic configuration as that of a conventional routing system. Components of the routing system according to an embodiment of the present invention have substantially the same function as those of the conventional routing system. For convenience of description, only components different from those of a conventional system are described below.

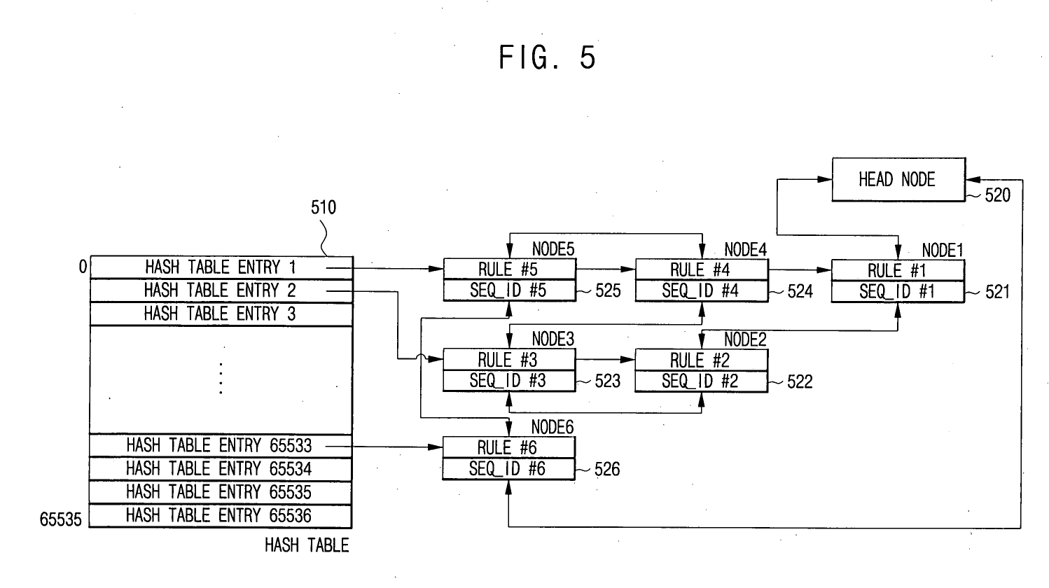

The entry manager 404 creates a hash table, a single linked list using an entry of the hash table as a head node, and a double linked list in order to manage mapping information between packet classifying/filtering rule information and a rule storage location of the TCAM 410. The hash table, the single linked list, and the double linked list will be described in detail with reference to FIG. 5.

The entry manager 404 searches a hash table entry matching a hash key, which is described below with reference to FIG. 5.

FIG. 5 is a view of a connection relationship among a hash table, a single linked list, and a double linked list created to manage rule entries of the TCAM 410 in the present invention.

The hash table 510 includes hash keys. As shown in FIG. 5, the hash table 510 is associated with the single linked list and the double linked list. The entry manager 404 can rapidly store or delete rules in the TCAM 410 by referring to the hash table. The hash key constituting the entry of the hash table 510 is defined, as follows:

Hash Key=[(Direction<<15)|(Rule ID<<8)|Port ID]&0xFFFF

The hash key may consist of a rule ID for identifying packet classifying/filtering rules, an interface index (port ID) to which the rule is applied, an interface direction, and the like. The rule ID refers to a unique ID assigned to each packet classifying/filtering rule in order to identify the packet classifying/filtering rule. The direction refers to a direction of the interface to which the rule is applied, and includes ingress and egress for each interface. Finally, the port ID indicates an index of the interface to which the rule is applied.

For example, if the hash table 510 has a key size 16 bits, since 2¹⁶=65536, there are 65536 hash keys. Accordingly, the hash table 510 has table entries 0 to 65535.

The single linked list uses the entry of the hash table 510 as a head node. Each of nodes constituting the single linked list has a rule ID, an interface index, and an assigned sequence ID. The entry manager 404 creates the single linked list for a case where the defined key size of the hash table 510 cannot cover all combinations of the rule ID, the interface index, and the interface direction due to a limited capacity of the memory.

For example, in FIG. 5, the single linked list may be created for each hash table entry. The single linked list using the hash table entry 1 as the head node sequentially links node 5 525, node 4 524 and node 1 521. The single linked list using the hash table entry 2 as the head node sequentially links node 3 523 and node 2 522. The single linked list using the hash table entry 65533 as the head node includes only the node 6 526.

The double linked list consists of an independent head node 520 and the nodes constituting the single linked list. The double linked list 520 bidirectionally links the respective nodes of the single linked list in the order of the sequence IDs about the independent head node. The single linked list uses the entry of the hash table 510 as the head node while the double linked list has the independent head node 520.

The double linked list guarantees the order of the sequence IDs indicating a storage location of the TCAM 410. To guarantee the order, the double linked list includes a forward list and a backward list. In the forward list, the head node 520 of the double linked list indicates a node having the smallest sequence ID value. That it, the forward list links the nodes in an order from a node having the smallest sequence ID value to a node having the greatest sequence ID value. The forward list indicates an order in which rules are stored in the TCAM 410. In the backward list, the head node 520 indicates the node having the greatest sequence ID value among the nodes linked by the double linked list. The backward list links the nodes in an order from the node having the greatest sequence ID value to the node having the smallest sequence ID value. The backward list is used to rapidly add a new rule to the double linked list.

In FIG. 5, the forward list sequentially links node 1 521, node 2 522, node 3 523, node 4 524, node 5 525, and node 6 526. On the other hand, the backward list sequentially links node 6 526, node 5 525, node 4 524, node 3 523, node 2 522, and node 1 521.

For convenience of description, a maximum number of the entries in the TCAM is assumed to be 8. Defined parameters associated with the TCAM are described as follows.

The Number of Free Entries indicates the number of entries doesn't having a stored rule among the entries in the TCAM 410. Where there is no rule stored in the TCAM 410, the value of the Number of Free Entries is “8”. The Number of Free Entries value decreases each time a rule is stored in the TCAM 410 and increases each time a rule is deleted from the TCAM 410.

The Next Sequence ID indicates a location of the TCAM 410 at which a rule will be stored when the rule is received subsequently. Where there is no rule stored in the TCAM 410, the Next Sequence ID will be 1. (To guarantee a priority of rules according to a rule input order, a sequence ID indicating a store location of the TCAM 410 increases by 1, as mentioned above.) Accordingly, the Next Sequence ID value becomes “1”. The Next Sequence ID value increases by “1” each time a rule is stored in the TCAM 410. If a deleted rule is added to the TCAM 410 again, the Next Sequence ID is initialized into the most recently assigned sequence ID value in the forward list of the double linked list after sequence ID reassignment is performed before the new rule is added.

The Left Sequence ID indicates the number of non-used entries in the TCAM 410 from the Next Sequence ID to a maximum sequence ID. Where there is no rule stored in the TCAM 410, the Left Sequence ID value is “8”. The Left Sequence ID value decreases each time a rule is stored in the TCAM 410. After the Sequence ID reassignment is performed, the Left Sequence ID is initialized into the Number of Free Entries value.

The Used Sequence ID indicates the number of available entries in the TCAM 410 before the Next Sequence ID. When none of the rules stored in the TCAM 410 are deleted and are thus kept unchanged, the Used Sequence ID value is “0”. The Used Sequence ID value increases each time a rule is deleted from the TCAM 410. After the Sequence ID reassignment is performed, the Used Sequence ID value is initialized into “0”.

A rule-entry management method in which a rule is rapidly stored or deleted in the TCAM using the hash table, the single linked list, and the double linked list are described in greater detail as follows.

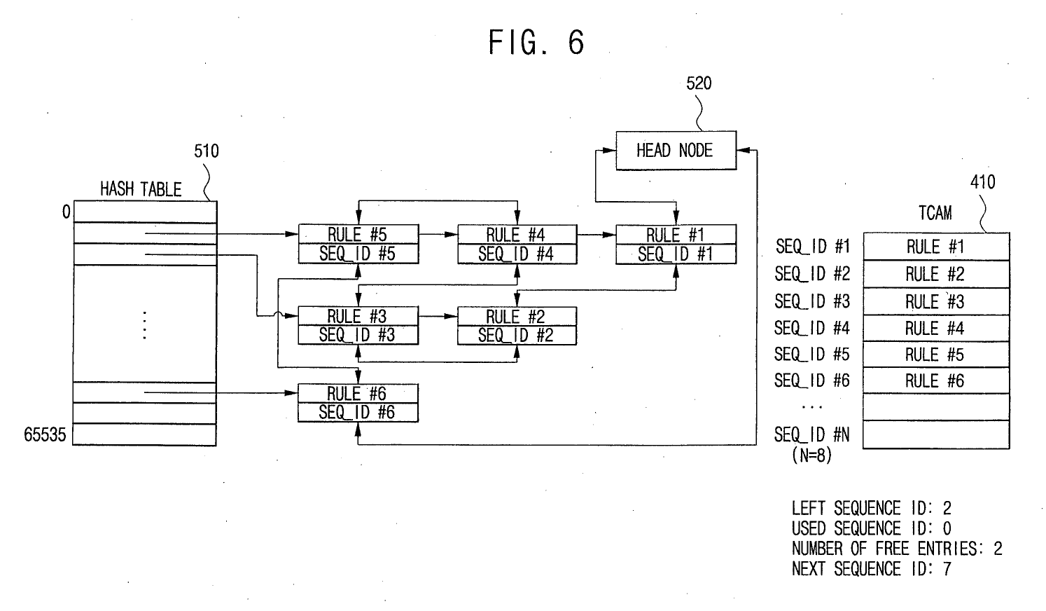

FIG. 6 is a hash table, a single linked list, a double linked list and a TCAM after a new rule is added in a state where five rules are already stored.

For example, it is assumed that rule #1 is a packet classifying/filtering rule by which rule ID 0 is applied to an ingress of interface index 1, rule #2 is a rule by which rule ID 0 is applied to an ingress of interface index 2, rule #3 is a rule by which rule ID 129 is applied to an ingress of interface index 2, rule #4 is a rule by which rule ID 129 is applied to an ingress of interface index 1, rule #5 is a rule by which rule ID 257 is applied to an ingress of interface index 1, and rule #6 is a rule by which rule ID 128 is applied to an egress of interface index 13.

As shown in FIG. 6, information on the six rules is stored in the TCAM 410. The rules input to the TCAM 410 are sequentially stored in sequence ID 1 to sequence ID 6. Accordingly, a subsequently input rule is stored in at location of sequence ID 7 in the TCAM 410. Accordingly, a Next Sequence ID becomes 7.

Since the maximum number of the entries of the TCAM 410 is 8 and the Next Sequence ID is 7, the number of non-used entries in the TCAM 410 from the Next Sequence ID 7 to the last sequence ID 8 is two. Accordingly, the Left Sequence ID value is 2. Further, since the number of the entries of the TCAM 410 in which the rule is not stored is 2, the Number of Free Entries value also becomes 2.

The six rules stored in the TCAM 410 are not deleted or added on the way but are kept unchanged. Accordingly, there is no available entry of the TCAM 410 before the Next Sequence ID 7. The Used Sequence ID value is 0.

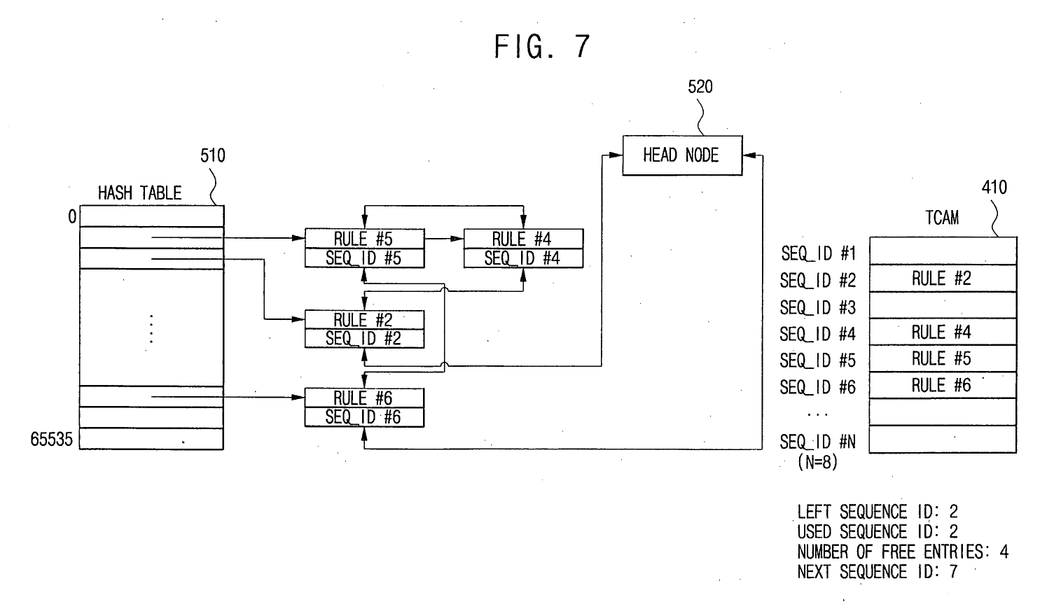

FIG. 7 is a view of a change in the TCAM structure and the mapping information after rule #1 and rule #3 are deleted from the TCAM in FIG. 6.

A subsequently input rule is stored at a location of sequence ID 7 in the TCAM 410. Accordingly, the Next Sequence ID is 7, as in FIG. 6. Since the number of the non-used entries from the Next Sequence ID 7 to last sequence ID 8 in the TCAM 410 is 2, the Left Sequence ID value becomes 2.

However, since rule #1 and rule #3 among the six stored rules were deleted from the TCAM 410, there are no rules stored in the entries of the TCAM 410 corresponding to sequence ID 1 and sequence ID 3. In FIG. 6, the number of the available entries in the TCAM 410 is two. However, since rule #1 and rule #3 were deleted, the number of non-used entries in the TCAM 410 increases to four. Accordingly, the Number of Free Entry value is changed to 4.

Since the two of the six rules stored in the TCAM 410 were deleted, the number of the entries available before the Next Sequence ID 7 in the TCAM 410 increases to 2. Accordingly, the Used Sequence ID value becomes 2. Since the sequence ID reassignment process is not yet performed, the Left Sequence ID value differs from the Number of Free Entries value.

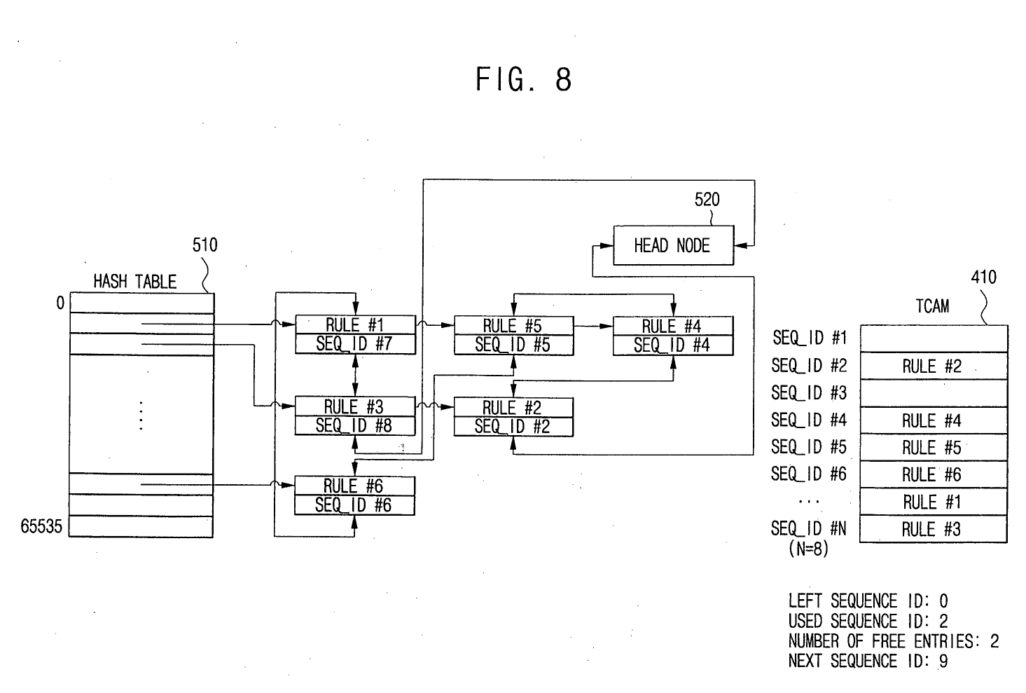

FIG. 8 is a view of a change in the TCAM structure and the mapping information when deleted rule #1 and rule #3 are added to the TCAM again.

In FIG. 8, the sequence ID reassignment process is not yet performed. Accordingly, even though there is an available entry of the TCAM 410 before the Next Sequence ID, the entry is ignored, and added rules are sequentially stored at the location of the Next Sequence ID and a next location in the TCAM 410. As described above, since the Next Sequence ID is 7, added rule #1 is stored at a location of sequence ID 7 in the TCAM 410. Accordingly, rule #3 is stored at a location of sequence ID 8.

In this case, since the rules are already stored at locations from sequence ID 1 to sequence ID 8, the Next Sequence ID value is changed from 7 to 9. Also, since the Next Sequence ID value is greater than the maximum Sequence ID value, there is no non-used entry of the TCAM 410 from the Next Sequence ID to the maximum Sequence ID. Accordingly, the Left Sequence ID value is 0.

Since the two rules are added to the TCAM 410 again, the number of the entries in which the rule is not stored of the TCAM 410 is reduced from 4 to 2. Accordingly, the Number of Free Entries value is changed from 4 to 2. Also, the Used Sequence ID value available before the Next Sequence ID value 9 is 2.

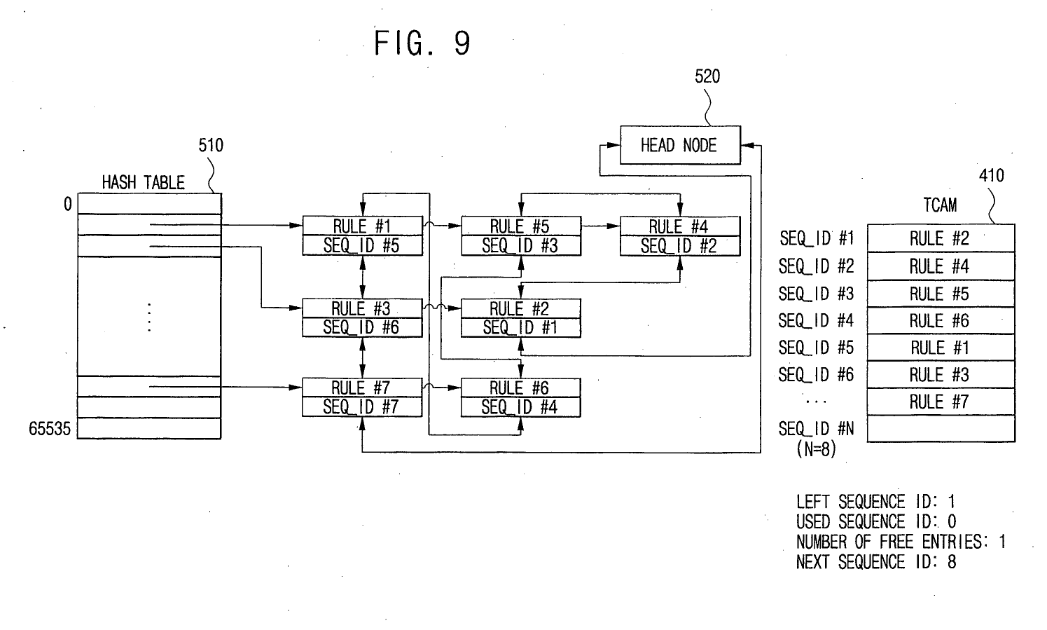

FIG. 9 is a view of a change in the TCAM structure and the mapping information after a sequence ID reassignment process is performed and then rule #7 is added to the TCAM.

As described above, a rule to be newly added to the TCAM 410 is stored at a location corresponding to the Next Sequence ID. However, as a previously stored rule is deleted from the TCAM 410, there may be an entry available before the Next Sequence ID in the TCAM 410. Accordingly, it is necessary to perform the sequence ID reassignment process for more efficient management of the entries in the TCAM 410.

In the sequence ID reassignment process, the rules currently stored in the TCAM 410 are again assigned sequence ID values according to their priorities. For example, in FIG. 9, sequence ID 1, 2, 3, 4, 5 and 6 are assigned to rule #2, #4, #5, #6, #1 and #3, respectively. After the sequence ID reassignment process is performed, there is no sequence ID available before the Next Sequence ID. A subsequently added rule #7 is stored at a location corresponding to sequence ID 7.

In the changed structure of the TCAM 410, since a subsequently added rule will be stored at a location of sequence ID 8, the Next Sequence ID value becomes 8. Furthermore, since the non-used entry of the TCAM 410 from Next Sequence ID to the last Sequence ID is only the entry of sequence ID 8, the Left Sequence ID value is 1. Since the entry of the TCAM 410 in which a rule is not stored is only the entry corresponding to sequence ID 8, the Number of Free Entries value becomes 1. However, since the TCAM 410 was subject to the sequence ID reassignment process, there is no entry available before the Next Sequence ID. Accordingly, the Used Sequence ID value was changed into 0.

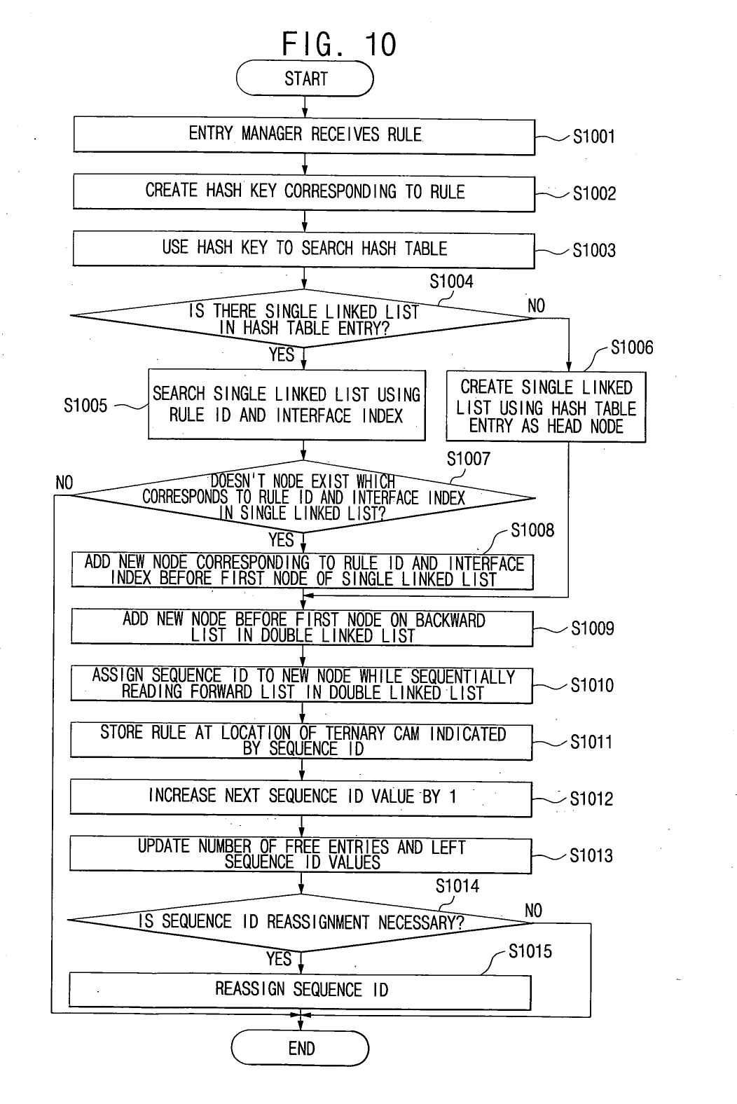

FIG. 10 is a flowchart of a process of adding a rule to a TCAM according to an embodiment of the present invention.

The entry manager 404 receives a packet classifying/filtering rule from the interface 402 (S1001). The entry manager 404 creates a hash key corresponding to the rule (S1002). The entry manager 404 uses the created hash key to search the hash table 510 (S1003), and looks up the hash table entry corresponding to the hash key.

The entry manager 404 determines whether there is a single linked list using the searched hash table entry as the head node (S1004). When there is the single linked list, the entry manager 404 searches the single linked list using the rule ID and the interface index (S1005). In this case, the entry manager 404 determines whether a node corresponding to the rule ID and the interface index exists in the single linked list (S1007). If the node corresponding to the rule ID and the interface index exists, all processes end since the received rule does not have to be added to the TCAM 410.

However, if the node corresponding to the rule ID and the interface index does not exist, the entry manager 404 adds a new node corresponding to the rule ID and the interface index before the first node of the single linked list (S1008). The entry manager 404 also adds the new node before the first node on the backward list in the double linked list (S1009).

If it is determined in S1004 that the single linked list does not exist, the entry manager 404 creates the single linked list using the hash table entry as the head node (S1006). Step S1009 is then performed.

If the single linked list and the double linked list are both updated, the entry manager 404 assigns a sequence ID to the new node while sequentially reading the forward list in the double linked list (S1010). In this case, corresponding sequence IDs are assigned to the rules included in each node.

The entry manager 404 stores the rule corresponding to the sequence ID at a location of the TCAM 410 indicated by the sequence ID (S1011). In this case, the entry manager 404 increases the Next Sequence ID value by 1 (S1012) and updates the Number of Free Entries and Left Sequence ID values (S1013).

The entry manager 404 determines whether the sequence ID reassignment is necessary (S1014). If the sequence ID reassignment is necessary, the entry manager 404 reassigns sequence IDs to the entries of the TCAM 410 (S1015). However, when the sequence ID reassignment process is unnecessary, the process of adding rules to the TCAM 410 ends.

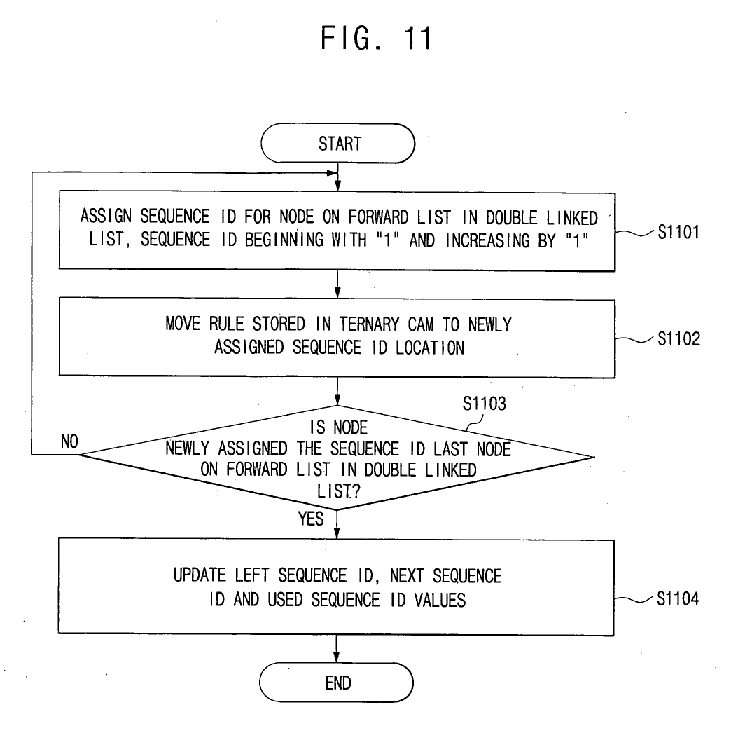

The sequence ID reassignment process is described in detail below with reference to FIG. 11.

FIG. 11 is a flowchart of the sequence ID reassignment process.

The sequence ID reassignment process is performed when the Left Sequence ID value is 0 and the Number of Free entries value is not 0. In this case, there is no non-used entry from the Next Sequence ID to the maximum Sequence ID (since the Left Sequence ID value is 0) and the Number of Free entries value is not 0. Accordingly, there are available entries in the TCAM 410. Hence, the entries of the TCAM 410 must be realigned and the rules must be sequentially input through the sequence ID reassignment process.

The sequence ID reassignment process is performed following a time corresponding to an absolute value of a value obtained by subtracting the Used Sequence ID value from the Left sequence ID value. However, when there is a great difference between the Left Sequence ID value and the Used Sequence ID value, the sequence IDs need to be realigned in advance. Hence, the sequence ID reassignment may be performed in advance.

When the sequence ID reassignment process is initiated, the entry manager 404 assigns a sequence ID for the node on the forward list in the double linked list, the sequence ID beginning with “1” and increasing by “1” (S1101). After assigning the sequence ID with an increment of 1, the entry manager 404 moves the rule stored in the TCAM 410 to the newly assigned sequence ID location (S102).

The entry manager 404 determines whether the node newly assigned the sequence ID is a last node on the forward list in the double linked list (S1103). When the node newly assigned the sequence ID is not the last node on the forward list, the process returns to S1101.

When the node newly assigned the sequence ID is the last node on the forward list, the entry manager 404 updates the Left Sequence ID, the Next Sequence ID and the Used Sequence ID values (S1104). Accordingly, the sequence ID reassignment process ends.

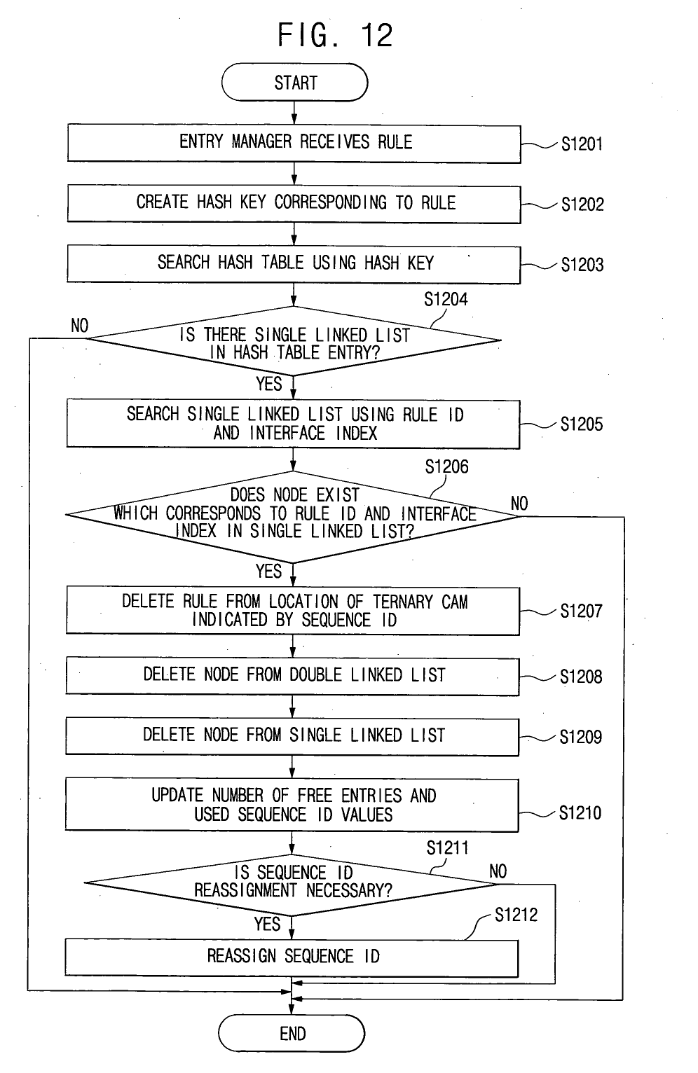

FIG. 12 is a flowchart of a process of deleting a rule from a TCAM according to an embodiment of the present invention.

The entry manager 404 receives a packet classifying/filtering rule to be deleted, from the interface 402 (S1201). The entry manager 404 then creates a hash key corresponding to the rule (S1202). The entry manager 404 searches the hash table 510 using the created hash key for a hash table entry corresponding to the hash key (S1203).

The entry manager 404 determines whether there is a single linked list using the looked-up hash table entry as the head node (S1204). If there is no single linked list, it means that the rule to be deleted is not stored in the TCAM 410. Accordingly, the rule deletion process ends.

If there is a single linked list, the entry manager 404 searches the single linked list using the rule ID and the interface index (S1205). The entry manager 404 then determines whether a node corresponding to the rule ID and the interface index exists in the single linked list (S1206). When the node corresponding to the rule ID and the interface index doesn't exist, the rule deletion process in the TCAM 410 ends.

However, when the node corresponding to the rule ID and the interface index exists, the entry manager 404 deletes the rule from a location of the TCAM 410 indicated by the sequence ID (S1207). After deleting the rule from the TCAM 410, the entry manager 404 deletes the node from the double linked list (S1208). The entry manager 404 also deletes the node from the single linked list (S1209).

The entry manager 404 then updates the Number of Free Entries value and the Used Sequence ID value (S1210). The entry manager 404 then determines whether the sequence ID reassignment is necessary (S1211) and, depending on the determination result, reassigns the sequence ID (S1212) or terminates the rule deletion process in the TCAM 410.

According to the present invention, the packet classifying/filtering rule can be easily added to the TCAM or deleted from the TCAM only with minimal information by using the hash table, the single linked list using the entry of the hash table as the head node, and the double linked list having the independent head node. Also, the sequence ID reassignment process, required for storing as many rules in the TCAM as possible according to the priority of the rules, is performed when a certain time elapses following rule addition or deletion, thereby reducing a latency that may be caused upon setting the packet classifying/filtering rule.

Furthermore, when the sequence ID is reassigned, the rule stored in the TCAM is copied to a location of the newly assigned sequence ID and then the rule stored at a previous location is deleted, thereby preventing the lookup processor from failing to obtain the packet forwarding information through the TCAM lookup performed on the received packet. The packet classifying/filtering rules are not separately stored upon managing the mapping information between the rule information and the rule storage location of the TCAM, which makes effective use of the memory possible.

While the present invention has been described with reference to exemplary embodiments thereof, it will be understood by those skilled in the art that various changes in form and detail may be made therein without departing from the scope of the present invention as defined by the following claims.

What is claimed is:

1. A method of managing rule entries of a Ternary Content Addressable Memory (TCAM) in a routing system, the method comprising:
creating a hash table having a hash key corresponding to each entry;
creating a single linked list for linking nodes, the single linked list using an entry of the hash table as a head node and the nodes including rule IDs and sequence IDs assigned according to a rule input order; and
creating a double linked list having an independent head node, the double linked list bidirectionally linking the nodes constituting the single linked list according to an order of the sequence IDs.

2. The method according to claim 1, wherein the hash key comprises a rule ID for identifying each packet classifying/filtering rule, an interface index to which the rule is applied, and an interface direction.

3. The method according to claim 1, wherein each node constituting the linked list further comprises information on an interface index to which the rule is applied.

4. A method of managing rule entries of a Ternary Content Addressable Memory (TCAM) in a routing system, the method comprising:
creating a hash key corresponding to a received rule and searching a hash table entry matching the hash key in response to receipt of a rule to be added to the TCAM;
determining whether a node matching information on the rule exists in a single linked list associated with the searched hash table entry; and
adding a new node including information on the received rule before a first node on the single linked list, and adding the new node before a first node on a backward list in a double linked list in response to the absence of a node matching the information on the rule.

5. The method according to claim 4, further comprising: assigning a sequence ID to the new node while reading the double linked list in an order of increasing sequence IDs, in response to the new node being added.

6. The method according to claim 4, further comprising storing the rule at a location of the TCAM indicated by the sequence ID.

7. The method according to claim 4, further comprising performing a search to determine whether a node corresponding to the rule ID and an interface index exists in the single linked list, and deleting the rule from a location of the TCAM indicated by a sequence ID included in the node corresponding to the rule ID and the interface index, in response to the received rule being a rule to be deleted from the TCAM.

8. The method according to claim 7, further comprising deleting the node from the double linked list and the single linked list, in response to the rule being deleted from the location of the TCAM.

9. The method according to claim 4, further comprising reassigning the sequence ID while sequentially reading the double linked list, in response to an entry in which a rule is not stored and no non-used entry from a sequence ID to be assigned to a subsequently received rule to a last sequence ID.

10. The method according to claim 7, further comprising reassigning the sequence ID while sequentially reading the double linked list, in response to an entry in which a rule is not stored and no non-used entry from a sequence ID to be assigned to a subsequently received rule to a last sequence ID.

11. The method according to claim 9, wherein reassigning the sequence ID is performed following a time corresponding to an absolute value of a value obtained by subtracting the number of available entries of the TCAM before the last sequence ID from the number of non-used entries of the TCAM from the sequence ID to be assigned to the subsequently received rule to the last sequence ID.

12. The method according to claim 10, wherein reassigning the sequence ID is performed following a time corresponding to an absolute value of a value obtained by subtracting the number of available entries of the TCAM before the last sequence ID from the number of non-used entries of the TCAM from the sequence ID to be assigned to the subsequently received rule to the last sequence ID.

13. The method according to claim 9, wherein reassigning the sequence ID comprises sequentially reassigning the sequence IDs to the respective nodes constituting the double linked list while reading the double linked list in an order of the increasing sequence ID, the reassigned sequence IDs beginning with 1.

14. The method according to claim 10, wherein reassigning the sequence ID comprises sequentially reassigning the sequence IDs to the respective nodes constituting the double linked list while reading the double linked list in an order of the increasing sequence ID, the reassigned sequence IDs beginning with 1.

15. A routing system comprising:
a network processor to create a hash table including a hash key, a single linked list for linking nodes, the single linked list using an entry of the hash table as a head node and linking the node including rule IDs and sequence IDs assigned according to a rule input order, and a double linked list having an independent head node, the double linked list bidirectionally linking the nodes constituting the single linked list according to an order of the sequence IDs; and
a Ternary Content Addressable Memory (TCAM) to store a rule included in the node in a TCAM entry indicated by a sequence ID assigned to the rule.

16. The system according to claim 15, wherein each entry of the hash table comprises hash key including a rule ID for identifying each packet classifying/filtering rule, an interface index to which the rule is applied, and an interface direction.

17. The system according to claim 16, wherein the single linked list uses the entry of the hash table as the head node, and sequentially links nodes including information on the rule ID or the interface index corresponding to the sequence ID and the hash key.

18. The system according to claim 16, wherein the double linked list links respective nodes constituting the single linked list about the independent head node according to an order of an increasing or decreasing sequence ID.

19. The system according to claim 15, wherein the network processor comprises:
an interface to provide entry management information to an entry manager, the entry management information including information on a packet classifying/filtering rule and information for addition or deletion of any rule to or from the TCAM; and
the entry manager creating the hash table, the single linked list, and the double linked list, and storing or deleting any rule to or from the TCAM according to the entry management information by referring to the hash table, the single linked list, and the double linked list.

20. The system according to claim 15, wherein the network processor further comprises a lookup processor to filter a packet or to apply a packet classification-dependent policy according to packet forwarding information obtained by looking up the TCAM.

21. The system according to claim 15, further comprising a subsidiary memory to store forwarding information for a packet corresponding to each rule stored in the TCAM.
